(19) United States
(12) Patent Application Publication
(10) Pub. No.: US 2006/0254328 A1
(43) Pub. Date: Nov. 16, 2006

(54) Locking mechanism with electronic solenoid opening and mechanical reset

(76) Inventor: Rune Sven Pearson, Katy, TX (US)

Correspondence Address: CONLEY ROSE, P.C., P. O. BOX 3267, HOUSTON, TX, 77253-3267, US

(21) Appl. No.: 11/126,756

(22) Filed: May 11, 2005

(51) Int. Cl. E05B 47/00; E05B 13/00

(52) U.S. Cl. 70/218; 70/277

(57) ABSTRACT

A locking mechanism with an electronic solenoid opening and a mechanical reset is disclosed. The locking mechanism comprises a solenoid which requires low power levels to activate and has a short activation period, resulting in reduced energy requirements and extended battery life. After being placed in the unlocked position, the locking mechanism remains unlocked until a mechanical reset is activated by a person turning a handle of the mechanism.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The embodiments of the present invention are directed toward methods and apparatus for providing a secure and reliable locking mechanism with an electronic solenoid unlock and a mechanical reset. The embodiments of the present invention can be utilized in locks that are commonly found in doors and that retract a latch bolt or striker via rotation of a door handle or knob.

When a conventional door lock is placed in the locked position, rotation of the door handle or knob is prevented due to a steel member that creates a shear condition between the door and a rotating member that is connected to the outer door handle. This shear condition can be disabled by a conventional tumbler type lock located in the inner door handle or knob. Although tumbler type locks are simple and relatively inexpensive, these locks are vulnerable in many aspects. For example, tumbler locks can be mechanically manipulated (or “picked”) by a person who does not have a key. In addition, unauthorized duplicate keys can also create safety concerns. With conventional tumbler locks, unauthorized access can often be obtained by using a large wrench or lever to break off the external handle. This provides access to the door latching mechanism, which can then be retracted manually. Furthermore, conventional locks typically require that a hole of approximately two inches or larger be drilled in the door to install the lock. This weakens the door in the area of the lock and creates further safety concerns.

Although known electronic locks address some of these concerns, they also have undesirable features. For example, certain prior art electronic locks activate a solenoid (or motor) for a specific period of time, usually a few seconds, in order to unlock the door. In such devices, the mechanism is only unlocked during the time interval in which the solenoid or motor is activated. The user must therefore activate the solenoid, typically by using an electronic key or by entering a code on a keypad, and then open the door during the time period in which the solenoid is activated. Opening the door within a relatively short time window can be quite bothersome if the user has items that he or she is trying to carry after opening the door, or if the user must open the door repeatedly.

Conventional electronic locks such as those described above utilize a solenoid (or motor) that converts electrical energy to mechanical energy needed to move the mechanism from a locked to an unlocked position. The electrical energy is typically provided from a permanent alternating current source (i.e. “hard-wiring” the locking mechanism) or from a direct current battery. Hard-wiring the lock can lead to significant increases in installation costs and render the lock inoperable in the event of a power failure. While a battery has lower installation costs, it must be replaced when it is no longer capable of providing sufficient electrical energy to activate the solenoid. Since the available space within a door lock is very limited, a small battery must be used and therefore a limited amount of electrical energy is available.

The energy produced by a battery is the product of the current produced, the voltage measured across the battery terminals, and the length of time that the current is produced. A conventional battery has a finite life, typically measured in ampere-hours, defined as the amount of time a battery will be able to produce a specified current at a specified voltage. In an electronic locking mechanism, each time the solenoid is activated, a certain amount of energy will be drawn from the battery, thereby reducing remaining battery life. In order to maximize battery life, it is therefore desirable to minimize the amount of energy that is drawn from the battery during the solenoid activation. This can be accomplished by reducing either the length of time the solenoid is activated or reducing the electrical power (i.e., the current multiplied by the voltage) drawn from the battery during the period of activation.

Reducing the electrical power consumed from the battery can be accomplished by reducing the mechanical power produced by the solenoid. However, the mechanical power produced by the solenoid must be sufficient to unlock or lock the mechanism. In certain prior art designs, sufficient mechanical power must be provided to account for factors which increase the power needed to unlock the mechanism. These factors include misalignment of the door and door frame, door warpage, or increased friction between components.

### SUMMARY OF THE PREFERRED EMBODIMENTS

Embodiments of the present invention relate to methods and apparatus comprising a locking mechanism with an electronic solenoid opening and a mechanical reset. Certain embodiments of the present invention comprise a solenoid that requires low power levels to activate and a solenoid activation period that is relatively short. This results in reduced energy consumption and extends the life of a battery used to power the mechanism. Some embodiments of the present invention also comprise a reset or re-locking mechanism utilizing a pin and collar with an inclined surface, or cam, which is activated by a person turning a handle of the locking mechanism. Therefore the reset mechanism does not rely on the solenoid to reset, and it is less susceptible to malfunction that might arise due to increased friction caused by wear or misalignment. In addition, certain embodiments of the present invention may comprise a security plate and other components that provide increased reliability and security.

### BRIEF DESCRIPTION OF THE DRAWINGS

FIG. 1 is an exploded view of a locking mechanism;

FIG. 2 is a side view of a partial assembly the locking mechanism of FIG. 1;

FIG. 3 is a side view of the locking mechanism of FIG. 1 in a locked position;

FIG. 4 is a side view of the locking mechanism of FIG. 1 in an intermediate position;

FIG. 5 is a side view of a locking mechanism of FIG. 1 in an unlocked position;

FIG. 6 is an end view of a locking mechanism of FIG. 1;

FIG. 7 is a top view of an alternative embodiment of a locking mechanism; and

FIG. 8 is an end view of the embodiment of FIG. 7.

### DETAILED DESCRIPTION OF THE PREFERRED EMBODIMENTS

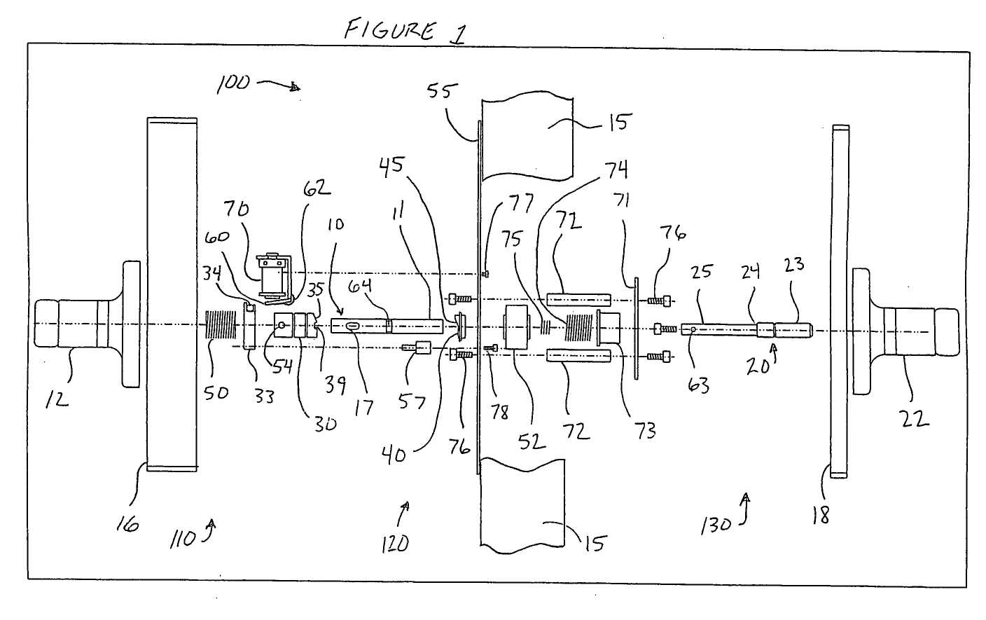

Referring initially to FIGS. 1-5, a locking mechanism 100 is shown relative to a door 15. As shown in the exploded view of FIG. 1, locking mechanism 100 comprises an inner shaft assembly 110, a door assembly 120 and an outer shaft assembly 130. The components of inner shaft assembly 110 will be described initially, followed by the components of the other assemblies. Inner shaft assembly 110 comprises an inner shaft 10 with an inner handle 12 and an inner collar 30, both disposed on inner shaft 10. Inner shaft 10 further comprises a radial slot 64, an axial slot 17, and an engagement portion 11. Further disposed on inner collar 30 are a release member 33 with a magnet 34 and a release biasing member 50. Inner collar 30 further comprises a guide pin 54, a notch 39, and a first cam or inclined surface 35.

Door assembly 120 comprises an inner protective cover 16, a security plate 55, and an outer protective cover 18. A solenoid 70, with a latching member 60 and a solenoid biasing member 62, is connected to security plate 55 via a fastener 77. A stationary collar 40 is disposed on security plate 55, in addition to an anti-rotation member 57 via a fastener 78. Stationary collar 40 comprises a second cam or inclined surface 45. A plurality of standoffs 72 are connected to security plate 55 via a plurality of fasteners 76. Door assembly 120 further comprises a striker 52, a striker cover 71, a primary biasing member 74, a secondary biasing member 75, and a biasing member guard 73. In certain embodiments, solenoid 70 is a 6 volt solenoid with 30 ohm resistance wiring and solenoid biasing member is an arc-shaped metallic component approximately 0.004″ thick.

Outer assembly 130 comprises an outer shaft 20 with a proximal portion 25 and a distal portion 23. A pin 63 is disposed on proximal portion 25 and an outer handle 22 is disposed on distal portion 23. A shoulder 24 is disposed between proximal portion 25 and distal portion 23.

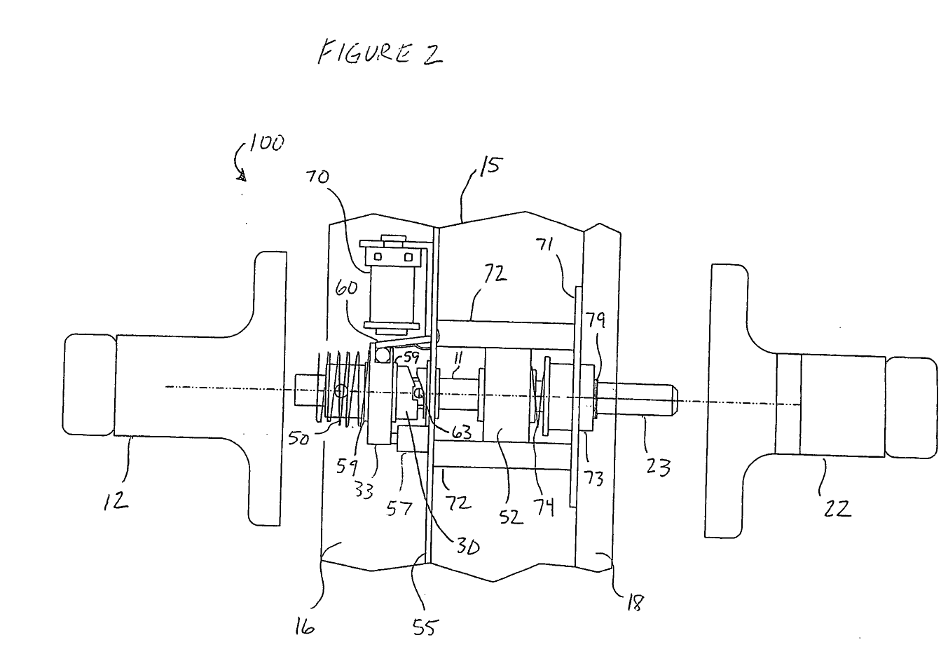

It is understood that the same embodiment depicted in FIG. 1 is also depicted in FIGS. 2-5. For purposes of clarity, not all of the components shown in the exploded view of FIG. 1 are shown in FIGS. 2-5. In addition, some of the components in the assembled views of FIGS. 2-5 are not labeled for purposes of clarity.

As shown in the partial assembly of FIG. 2, striker 52 and standoffs 72 are disposed between striker cover 71 and security plate 55. Inner shaft 10 extends through inner collar 30, stationary collar 40, security plate 55 and into striker 52. Outer shaft 20 extends through outer protective cover 18, biasing member guard 73, striker cover 71, striker 52 and into inner shaft 10. Solenoid 70 is positioned so that latching member 60 can engage release member 33 on collar 30. Biasing member guard 73 is disposed on outer shaft 20 and held in place by a retaining ring 79. Primary biasing member 74 (shown in FIG. 1) is not shown in FIG. 2 for clarity, but is normally disposed between striker 52 and biasing member guard 73. Secondary biasing member 75 (also not shown in FIG. 2 for clarity) is disposed between a shoulder 24 on outer shaft 20 and the end of inner shaft 10 that is extended into striker 52. In this manner, secondary biasing member 75 biases outer shaft 20 away from inner shaft 10, and primary biasing member 74 biases outer shaft 20 towards outer handle 22. As discussed in greater detail below, pin 63 on outer shaft 20 extends through radial slot 64 of inner shaft 10; therefore, primary biasing member 74 will also bias inner shaft 10 towards outer handle 22.

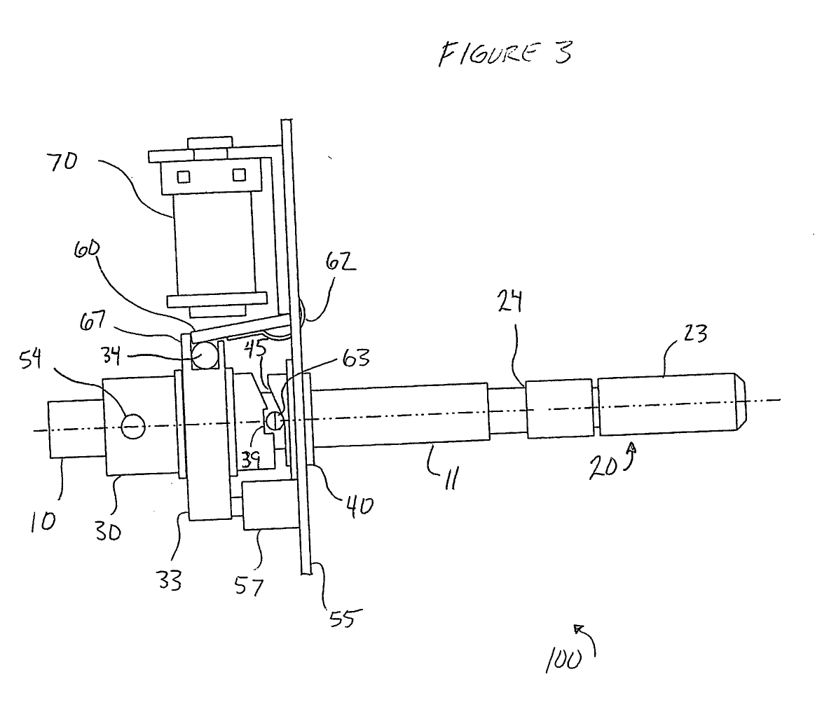

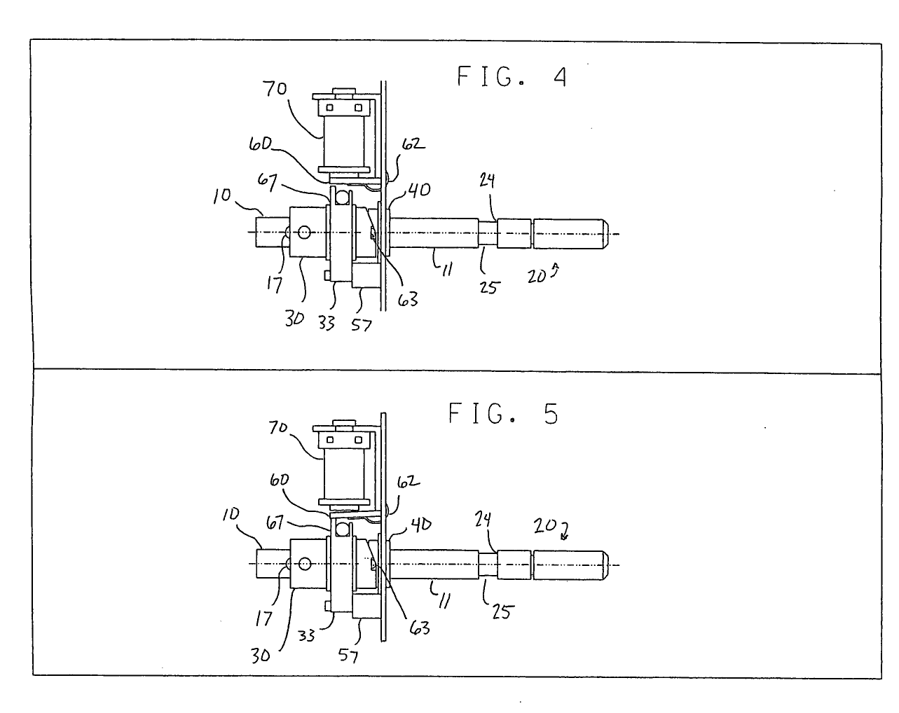

A general overview of locking mechanism 100 will be provided initially, followed by a more detailed description of the operation of locking mechanism 100. FIG. 3 depicts locking mechanism 100 in the “locked” position. In this position, outer handle 22 (placed on the side of door 15 that is to be secured) can not be used to open door 15. FIG. 4 depicts locking mechanism 100 in an intermediate position when solenoid 70 is being activated (i.e., an electric current is being supplied to solenoid 70). FIG. 5 depicts locking mechanism 100 in the “unlocked” position after solenoid 70 has been de-activated. In the position shown in FIG. 5, rotation of outer handle 22 can be used to open door 15. Locking mechanism 100 can only be used to open door 15 if inner shaft 10 is rotated, thereby allowing engagement portion 11 of inner shaft 10 to engage striker 52. The means for retracting a striker via the rotation of a shaft in a locking mechanism is well known in the art, and includes gear mechanisms such as a rack and pinion or equivalent means. In the positions shown in FIGS. 3-5, inner shaft 10 comprises a square cross section and inner handle 12 comprises a corresponding shaped recess into which inner shaft 10 extends. Therefore, rotation of inner handle 12 will cause inner shaft 10 to rotate and cause engagement portion 11 to retract striker 52, allowing a person to open door 15. Other embodiments may comprise different means for mounting handle 12 on inner shaft 10.

A significant difference between FIGS. 3 and 5 is the position of inner collar 30. In FIG. 3, inner collar 30 is separated from pin 63, so that rotation of outer handle 22 and outer shaft 20 will cause pin 63 to rotate within the gap between inner collar 30 and stationary collar 40. In FIG. 5, inner collar 30 is engaged with pin 63, so that rotation of outer handle 22 and outer shaft 20 will cause pin 63 to rotate inner collar 30. Guide pin 54 is connected to inner collar 30 and disposed within axial slot 17 of inner shaft 10; therefore, rotation of inner collar 30 will cause inner shaft 10 to also rotate.

In the embodiment of FIGS. 1-5, outer shaft 20 comprises distal portion 23 with a square cross section that fits into a corresponding square recess in outer handle 22 so that rotation of outer handle 22 will cause outer shaft 20 to rotate as well. In the embodiment shown, inner shaft 10 also comprises a square cross section that fits into a square recess of inner handle 12 so that rotation of inner handle 12 will cause inner shaft 10 to rotate in both the locked an unlocked positions so that a person can always exit in case of fire or other emergency. In the embodiment of FIGS. 1-5, outer shaft 20 also comprises proximal portion 25 which is disposed within inner shaft 10. Although proximal portion 25 is a round bar in the embodiment shown, proximal portion 25 may comprise other shapes in other embodiments. In the embodiment of FIGS. 1-5, inner shaft 10 is comprised of square tubing being about 0.310 inches square on the outside and about 0.230 inches square on the inside. As shown in FIGS. 1-5, inner shaft 10 extends from inner handle 12, through inner collar 30, stationary collar 40, and security plate 55. In the embodiment shown, distal portion 23 of outer shaft 20 is about 0.300 inches square and proximal portion 25 is approximately about 0.220 inches in diameter. With the above-described dimensions, outer shaft 20 may be rotated within, and independent from, inner shaft 10 when locking mechanism 100 is placed in the locked position.

In the embodiment shown, pin 63 is disposed upon or connected to outer shaft 20 in an orientation generally perpendicular to the primary axis of outer shaft 20. Pin 63 can be connected to shaft 20 in various manners, but in the embodiment shown pin 63 is a hardened pin pressed into a hole drilled in outer shaft 20. In the assembly of the embodiment shown, outer shaft 20 is inserted into inner shaft 10 before pin 63 is connected to outer shaft 20. Outer shaft 20 is positioned so that the hole in which pin 63 is going to be inserted is aligned with radial slot 64 of inner shaft 10. When the hole for pin 63 is aligned with radial slot 64, pin 63 can then be connected to shaft 20. Pin 63 is long enough that it extends through radial slot 64 and beyond the outer surface of inner shaft 10. After locking mechanism 100 is assembled, pin 63 is aligned with radial slot 64. This allows outer shaft 20 to be rotated the full ninety degrees right or left rotational movement allowed by handle 22, without rotating inner shaft 10 when locking mechanism 100 is in the locked position shown in FIG. 3, as described in more detail below.

In the locked position shown in FIG. 3, latching member 60 of solenoid 70 is engaged with magnet 34, so that latching member 60 is resting on top of and held in place by the magnetic attraction of magnet 34. In certain embodiments, latching member 60 is made of a ferromagnetic metal so that it is attracted to magnet 34. In addition, solenoid biasing member 62 biases latching member 60 towards magnet 34 so that the end of latching member 60 engages a lip 67 of release member 33. Release member 33 is disposed upon inner collar 30 and secured with a pair of retaining rings 59 (shown in FIG. 2). Release member 33 comprises an inner bore that is slightly larger than the outer diameter of inner collar 30 so that inner collar 30 may rotate independently of release member 33. In the embodiment shown, guide pin 54 is pressed into inner collar 30 and fits into axial slot 17 (not shown in FIGS. 3-5 for purposes of clarity) in inner shaft 10. Axial slot 17 in inner shaft 10 allows inner collar 30 to move a limited axial distance relative to inner shaft 10. In the locked position shown in FIG. 3, the engagement of latching member 60 with lip 67 and magnet 34 prevents release biasing member 50 from further biasing release member 33 and inner collar 30 towards stationary collar 40.

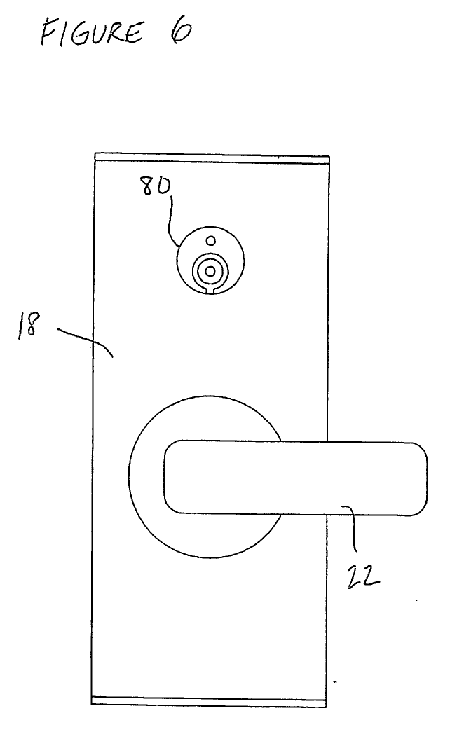

FIG. 4 shows locking mechanism 100 in an intermediate position while solenoid 70 is activated. The activation of solenoid 70 causes latching member 60 to be drawn up towards solenoid 70 and away from magnet 34. In certain embodiments, solenoid 70 is activated for a brief period of time (approximately 50 to 200 milliseconds), which reduces the amount of electrical energy needed to unlock locking mechanism 100. In certain embodiments, the electrical energy needed to activate solenoid 70 is provided by a lithium battery (not shown). As shown in the embodiment of FIG. 6, solenoid 70 can be activated when an electronic key reader 80 detects a code from an electronic key (also not shown) that is programmed to allow locking mechanism 100 to be unlocked. Other embodiments can comprise a small electric motor to perform the release action of latching member 60.

As shown in FIG. 4, when solenoid 70 is activated, latching member 60 is drawn towards solenoid 70 so that latching member 60 is no longer engaged with magnet 34 or lip 67 of release member 33. Minimizing the thickness of solenoid biasing member 62 (to 0.004 inches in certain embodiments) also reduces the amount of force that solenoid biasing member 62 exerts on latching member 60. This consequently reduces the amount of force that solenoid 70 must exert on latching member 62 to retract it to the position shown in FIG. 4 that is needed to unlatch latching member 60 from lip 67 and magnet 34. During the time latching member 60 is not engaged with magnet 34 or lip 67, release biasing member 50 moves release member 33 and inner collar 30 towards stationary collar 40 and pin 63. As shown in FIG. 5, when solenoid 70 is no longer activated, solenoid biasing member 62 and magnet 34 cause latching member 60 to move away from solenoid 70. However, because release member 33 has now moved towards pin 63, latching member 60 can no longer engage magnet 34 and lip 67 of release member 33. Instead, latching member 60 rests on top of lip 67. This allows pin 63 to engage notch 39 of inner collar 30.

In the position shown in FIG. 5, rotation of outer handle 22 (and outer shaft 20) will cause inner collar 30 to rotate because pin 63 is engaged with notch 39 of inner collar 30. Mounted on collar 30 is pin 54, which extends into slot 17 of inner shaft 10 to allow limited axial movement of collar 30 relative to inner shaft 10. While axial slot 17 is longer than the diameter of pin 54, it is only slightly wider than the diameter of pin 54. Therefore, the radial movement of inner collar 30 relative to inner shaft 10 is extremely limited and as inner collar 30 is rotated, inner shaft 10 will also be rotated. The cross section of inner collar 30 also comprises a circular exterior shape, which allows inner collar 30 to rotate relative to release member 33, which comprises a circular inner bore. Anti-rotation member 57 prevents release member 33 from rotating as inner collar 30 is rotated. Because release member 33 does not rotate, magnet 34 remains at the top of release member 33 and near latching member 60.

As shown in FIG. 5, if outer handle 22 is rotated counterclockwise (so that pin 63 moves down in the embodiment of FIG. 5), there will be no axial movement between stationary collar 40 and inner collar 30. If moved in this direction, pin 63 will follow the portion of stationary collar 40 that is substantially parallel with plate 55. However, if outer handle 22 is rotated clockwise (so that pin 63 moves up as shown in FIG. 5), pin 63 will travel along second inclined surface 45 of stationary collar 40. This will cause pin 63 to move axially away from outer handle 22 and cause primary biasing member 74 to compress. As pin 63 moves axially, it will impart an axial force on notch 39 of inner collar 30 sufficient to overcome the force imparted on inner collar 30 by release biasing member 50. This will cause inner collar 30 to move axially away from outer handle 22 and towards inner handle 12. Retaining rings 59 restrict release member 33 from moving axially relative to inner collar 30. Therefore, release member 33 will also move towards inner handle 12 when pin 63 pushes inner collar 30 in an axial direction as pin 63 is rotated clockwise.

In the embodiment shown in FIGS. 3-5, pin 63 has a round cross section in the portion that is engaged with outer shaft 20. However, in the portion of pin 63 that engages inner collar 30, pin 63 has been modified so that approximately half of its cross section has been removed. This allows a more positive engagement between pin 63 and notch 39 and also reduces the axial distance that inner collar 30 and release member 33 must travel in order to fully engage notch 39.

When release member 33 travels a sufficient axial distance (approximately 0.060 of an inch in certain embodiments), latching member 60, which is biased toward magnet 34 by solenoid biasing member 62, will engage magnet 34 and lip 67. This will restrict release biasing member 50 from axially displacing inner collar 30 and release member 33 towards outer handle 22. Therefore, pin 63 will not be able to engage notch 39 of inner collar 30 after handle 22 has returned to its central or neutral home position, and repeated rotation of outer handle 22 will not cause inner shaft 10 or engagement portion 11 to rotate. Consequently, locking mechanism 100 will be in a “locked” position such that rotation of outside handle 22 will not cause engagement portion 11 to rotate and engage striker 52, and therefore will not allow a person to open door 15 more than once per each key usage.

Similarly, if inner handle 12 is rotated in a counterclockwise position when the embodiment of FIGS. 1-5 is in the unlocked position (so that notch 39 moves in an upward direction as shown in FIG. 5), inner collar 30 will rotate pin 63 relative to stationary collar 40. Pin 63 will thereby engage second inclined surface 45 and cause inner collar 30 to move axially towards inner handle 12. Again, release member 33 is restricted from moving axially relative to inner collar 30. Therefore, as inner collar 30 moves, release member 33 will also move axially. When release member 33 moves a sufficient axial distance, latching member 60 will engage magnet 34 and lip 67 and restrict release biasing member 50 from moving release member 33 and inner collar 30 towards pin 63 after handle 12 is returned to its neutral position. As previously described, rotation of inner handle 12 will cause inner shaft 10 to rotate and retract striker 52, irrespective of whether locking mechanism 100 is in the locked or unlocked position.

To summarize the embodiment shown in FIGS. 1-5, if inner handle 12 is rotated counterclockwise or outer handle 22 is rotated clockwise when locking mechanism 100 is in the unlocked position, then locking mechanism 100 will be reset to the locked position. If inner handle 12 is rotated clockwise or outer handle 22 is rotated counterclockwise when locking mechanism is in the unlocked position, then locking mechanism 100 will remain in the unlocked position. The direction of rotation used to reset locking mechanism 100 is for the embodiment of FIGS. 1-5; other embodiments of the present invention may use different directions of rotation to reset locking mechanism 100 or may be designed to lock when either handle is rotated in either direction. Furthermore, the number of degrees or angular measure that inner handle 12 or outer handle 22 must be rotated to reset locking mechanism 100 will depend on the dimensions of various components, such as pin 63, stationary collar 40 and inner collar 30.

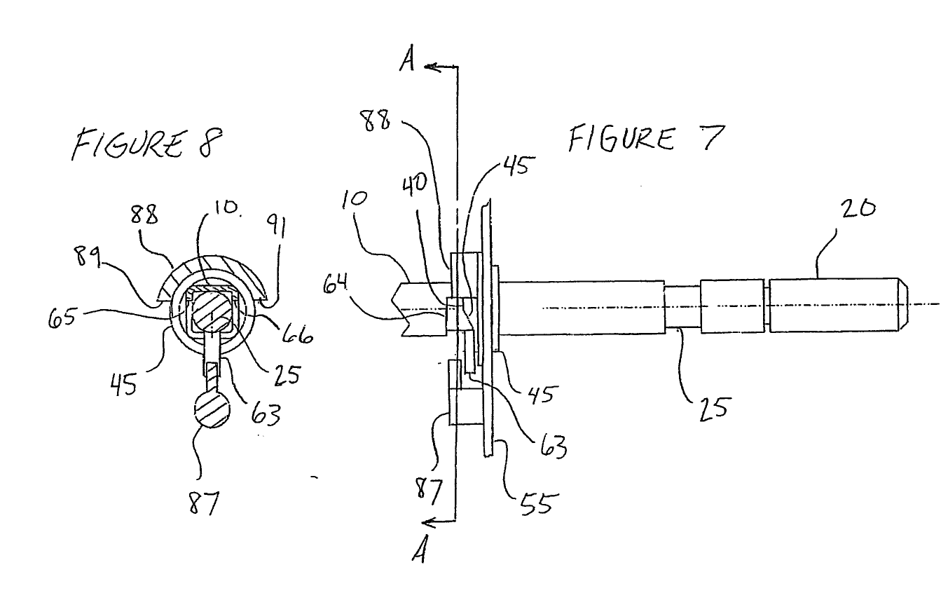

In addition to the embodiment of FIGS. 1-5, a second embodiment of locking mechanism 100 is shown in FIG. 7, which represents a top view of a partial assembly of locking mechanism 100. This embodiment comprises additional components that increase the security of locking mechanism 100 and make it more difficult for locking mechanism 100 to be manually manipulated. For sake of clarity, certain redundant components from the embodiment shown in FIGS. 1-5 are not shown in FIG. 7.

As shown in FIG. 7, a proximal end 25 of outer shaft 20 is disposed within inner shaft 10. Similar to the embodiment shown in FIGS. 1-6, pin 63 also extends through a radial slot 64 in inner shaft 10. A stationary collar 40 with an inclined or angled surface 45 is also disposed on a security plate 55. The embodiment shown in FIG. 7 operates in the same general manner to lock and unlock locking mechanism 100 as that described for the embodiment in FIGS. 1-6. However, the embodiment of FIG. 7 also comprises axial stop 87 disposed on security plate 55 and radial stop 88 disposed on stationary collar 40. These components provide additional security and make it more difficult for an individual to mechanically manipulate locking mechanism 100.

For example, without axial stop 87, it could be possible for a person to remove outer handle 22 and push outer shaft 20 in an axial direction towards first security plate 55. Pin 63 could thereby engage notch 39 of inner collar 30 (not shown in FIG. 7), allowing inner shaft 10 to be rotated and door 15 to be opened. However, axial stop 87 makes it more difficult to mechanically manipulate locking mechanism 100. In the embodiment shown in FIG. 7, if handle 22 is removed and shaft 20 is pushed in an axial direction towards security plate 55, pin 63 will engage will engage axial stop 87 and prevent pin 63 from engaging notch 39. Therefore, the axial manipulation of outer shaft 20 could not be used to mechanically unlock locking mechanism 100 and open door 15.

The embodiment in FIG. 7 further comprises radial stop 88, which also provides additional security for locking mechanism 100. In normal operation, outer handle 22 comprises internal tabs (not shown) which prevent handle 22 from being rotated more than 90 degrees. However, if outer handle 22 is removed and radial stop 88 was not present, outer shaft 20 could be rotated more than 90 degrees. This would allow pin 63 to engage the ends of radial slot 64 in inner shaft 10. With pin 63 engaging an end of radial slot 64, further rotation of outer shaft 20 would cause inner shaft 10 to rotate. This would also allow a person to mechanically unlock locking mechanism 100 and open door 15.

However, the addition of radial stop 88 prevents this manipulation of locking mechanism 100, as described in more detail below. FIG. 8 is a view of section A-A from FIG. 7 and depicts an end view of outer shaft 20 in a neutral or centered rotational position. As shown in FIG. 8, if outer shaft 20 is rotated approximately 90 degrees in either direction, pin 63 would engage radial stop 88 before it engages radial slot 64. Specifically, if outer shaft 20 is rotated approximately 90 degrees clockwise in the view of FIG. 8, pin 63 will engage end 89 of radial stop 88 before pin 63 engages end 65 of radial slot 64. Similarly, if outer shaft 20 is rotated approximately 90 degrees counter-clockwise, pin 63 will engage end 91 of radial stop 88 before it engages end 66 of radial slot 64. Therefore, outer shaft 20 cannot be rotated more than 90 degrees even if outer handle 22 is removed. As a result, locking mechanism 100 cannot be mechanically manipulated to allow pin 63 to engage either end 65 or end 66 of radial slot 64. Therefore, locking mechanism 100 cannot be operated in this manner to unlock and open door 15.

As described above, locking mechanism 100 comprises many safety, reliability, and convenience benefits. For example, solenoid 70 only requires a brief pulse activation (50-200 milliseconds in certain embodiments) to unlock locking mechanism 100, which remains unlocked after the solenoid activation period has ended. By remaining unlocked after solenoid 70 is activated, the solenoid activation period can be shortened because a user does not have to open door 15 during the solenoid activation period. The brief pulse needed to activate solenoid 70 in embodiments of the present invention thereby minimizes the amount of electrical energy that is consumed when locking mechanism 100 is unlocked. In addition, the design of solenoid biasing member 62 minimizes the mechanical forces that must be overcome to unlock locking mechanism 100. This also minimizes the amount of electrical energy that is used when unlocking locking mechanism 100.

In addition to reducing energy requirements, embodiments of the present invention allow a user to unlock the locking mechanism without having to open the door immediately. This feature is particularly useful when the user has items such as luggage that he or she wishes to carry after unlocking the door.

The embodiments described above also provide the convenience of allowing a user to open the door and either reset the locking mechanism to the locked position or have it remain unlocked, depending on which way the user turns the handle. This feature allows a user to electronically unlatch the mechanism and open the door repeatedly without having to unlock it each time; however, when the user wishes to lock the door after exiting, he or she may reset the locking mechanism simply by turning a handle in a certain direction.

Embodiments of the present invention also comprise features that allow for safe and reliable operation. For example, the use of magnet 34 and latching member 60, which is made of ferromagnetic material in certain embodiments, helps to ensure there is a positive engagement between latching member 60 and lip 67. In addition, solenoid biasing member 62 also biases latching member 60 towards magnet 34 to ensure positive engagement. Solenoid biasing member 62 and magnet 34 greatly reduce the likelihood that the components can be unlatched through the application of an external impact force. The placement of solenoid 70, latching member 60, and release member 33 also minimize the effects of door warpage or misalignment on the operation of locking mechanism 100. The movement of release member 33 is in an axial direction along inner shaft 10, and is therefore not dependent on the alignment between door 15 and a corresponding door frame (not shown). In certain prior art devices, misalignment or warpage of a door will negatively effect the operation of the locking mechanism.

Other safety features of locking mechanism 100 include security plate 55, striker cover 71, and inner and outer protective covers 16 and 18, which reduce the likelihood that an intruder would be able to mechanically unlock the locking mechanism by forcibly removing outer handle 22. In certain prior art devices, removal of an external handle can expose components that can be mechanically manipulated to unlock the locking mechanism. In certain embodiments described above, inner and outer protective covers 16 and 18, security plate 55, and striker cover 71 are made of steel or other suitably strong materials to reduce the likelihood that these components could be breached. In certain embodiments of the present invention using an electronic key, safety is also improved due to the vast number of codes available to program the key that is used to activate the solenoid. The number of key codes available greatly reduces the likelihood of an unauthorized duplicate code being used to unlock the locking mechanism.

Some embodiments of the present invention also provide safety benefits because the locking mechanism does not rely on a solenoid or motor to return to the locked position. A user can manually re-lock the mechanism by simply turning a handle in a certain direction. Thus, the re-locking mechanism is not limited to the power supplied by the solenoid or motor, and therefore is not as susceptible to increased frictional forces within the locking mechanism.

Certain embodiments of the present invention also include the benefit of providing additional structural support to a door. For example, when a locking mechanism such as the embodiment shown in FIG. 2 is installed in a door, inner protective cover 16, outer protective cover 18, security plate 55, and striker cover 71 all provide additional stiffening and structural support to the door. These features reduce the likelihood that an intruder could gain access to a location by forcibly pushing or pulling on the door or the door handle.

While various preferred embodiments of the invention have been shown and described, modifications thereof can be made by one skilled in the art without departing from the spirit and teachings of the invention. The embodiments herein are exemplary only, and are not limiting. Many variations and modifications of the apparatus and methods disclosed herein are possible and within the scope of the invention. For example, embodiments described herein comprise shafts of square and round cross sections; other embodiments may comprise shafts of with cross sections of different shapes. In addition, embodiments described herein utilize an electronic key to unlock the locking mechanism; other embodiments may comprise a keypad to enter an authorization code or other means for activating an electric solenoid. Furthermore, embodiments described herein comprise a solenoid with a flapper style latch; other embodiments may comprise a solenoid with a different configuration, such as a solenoid with a pin or rod that extends and retracts. Additionally, other embodiments may combine some of the components described herein. For example, other embodiments may combine the second collar and security plate into a single component. Terms used herein are intended to be interpreted broadly. For example, use of the term “connect” (and variations thereof) to describe the relationship between components is not intended to require a direct connection between the components. Accordingly, the scope of protection is not limited by the description set out above, but is only limited by the claims which follow, that scope including all equivalents of the subject matter of the claims.

What is claimed is:

1. A locking mechanism comprising:
a release member;
a latching member, wherein said latching member holds said locking mechanism in a locked position when said latching member is engaged with said release member;
a solenoid, wherein said latching member becomes disengaged from said release member and said locking mechanism is in an unlocked position after said solenoid is activated; and
a reset mechanism comprising a first shaft, wherein said latching member becomes engaged with said release member when said first shaft is rotated.

2. The locking mechanism of claim 1 wherein:
said solenoid is activated for less than 300 milliseconds.

3. The locking mechanism of 1 wherein said release member travels in a direction substantially parallel to said first shaft when said latching member is disengaged from said release member.

4. The locking mechanism of claim 3 wherein:
said release member travels less than 0.100 inches when said latching member is disengaged from said release member.

5. The locking mechanism of claim 1 further comprising:
a first handle disposed on said first shaft, wherein said latching member is engaged with said release member when said first handle is rotated.

6. The locking mechanism of claim 5 wherein:
said latching member is engaged with said release member when said first handle is rotated approximately 90 degrees in a first direction and said latching member is not engaged with said release member when said first handle is rotated approximately 90 degrees in a second direction opposite of said first direction.

7. The locking mechanism of claim 5 further comprising:
a second handle disposed on a second shaft, wherein said latching member is engaged with said release member when said second handle is rotated.

8. The locking mechanism of claim 7 wherein said first handle or said second handle is rotated by a person.

9. The locking mechanism of claim 1, wherein:
said locking mechanism is installed in a door and a first side of said door is secured so that said door cannot be opened unless said locking mechanism is in an unlocked position; and
wherein said locking mechanism further comprises a security plate that restricts access to said latching member from said first side of said door.

10. A locking mechanism comprising:
a solenoid, wherein said locking mechanism is in an unlocked position after an electrical current is applied to said solenoid; and
a mechanical relocking mechanism comprising a shaft, wherein rotation of said shaft in a first direction moves said locking mechanism to a locked position.

11. The locking mechanism of claim 10 wherein:
said electrical current is supplied to said solenoid for less than 300 milliseconds.

12. The locking mechanism of claim 10, further comprising:
an inclined surface adjacent to said shaft; and
a pin disposed on said shaft, wherein said pin engages said inclined surface when said shaft is rotated in said first direction.

13. The locking mechanism of claim 10, further comprising:
a latching member adjacent to said solenoid; and
a magnet that engages said latching member when said locking mechanism is in said locked position and does not engage said latching member when said locking mechanism is in said unlocked position.

14. The locking mechanism of claim 10, further comprising:
a security plate on one side of said solenoid.

15. The locking mechanism of claim 10, further comprising:
a cover plate that covers said locking mechanism and adds structural support to a door in which said locking mechanism is installed.

16. A locking mechanism comprising:
a first shaft;
a first collar disposed on said first shaft;
a second shaft;
a second collar, wherein said second shaft is disposed through said second collar;
a biasing member biasing said first collar towards said second collar;
a pin disposed on said second shaft that engages an inclined surface on said second collar;
a notch on said first collar that engages said pin when said locking mechanism is in an unlocked position and does not engage said pin when said locking mechanism is in a locked position;
a latching member that restricts said first collar from moving in an axial direction towards said second collar when said locking mechanism is in a locked position; and
a solenoid, wherein activation of said solenoid releases said latching member and allows said first collar to move towards said second collar.

17. The locking mechanism of claim 16 wherein:
rotation of said second shaft in a first direction does not cause said pin to move said first collar in an axial direction away from said second collar when said locking mechanism is in said unlocked position.

18. The locking mechanism of claim 17, wherein:
rotation of said second shaft in a second direction causes said pin to move said first collar in an axial direction away from said second collar when said locking mechanism is in said unlocked position.

19. The locking mechanism of claim 16, further comprising:
a magnet that engages said latching member when said locking mechanism is in said locked position.

20. The locking mechanism of claim 16, further comprising:
a release member disposed on said first collar, wherein said magnet is disposed on said release member and said release member comprises a lip which engages said latching member when said locking mechanism is in said unlocked position.

21. The locking mechanism of claim 16 wherein:
said first collar rotates with said first shaft when said first shaft is rotated;
said first collar can travel a limited axial distance relative to said first shaft; and
said first collar can be rotated independently of said release member.

22. The locking mechanism of claim 16, further comprising:
a first handle disposed on said first shaft;
a second handle disposed on said second shaft; and
a security plate between said latching member and said second handle.

23. The locking mechanism of claim 16 wherein:
one end of said second shaft is disposed within one end of said first shaft;
said first shaft comprises a radial slot; and
said pin extends through said radial slot.

24. The locking mechanism of claim 16 wherein:
said first shaft comprises an axial slot;
a second pin is disposed on said first collar; and
said second pin extends in said axial slot.

25. A locking mechanism comprising:
a first handle;
a second handle;
a shaft connected to either said first handle or said second handle;
a latching member; and
a release member engaged with said latching member, wherein said release member moves axially along said shaft after said latching member is disengaged from said release member.

26. The locking mechanism of claim 25 further comprising means for disengaging said latching member from said release member.

27. The locking mechanism of claim 26 wherein said means for unlatching said latching member is activated by a pulse to a solenoid or motor.

28. The locking mechanism of claim 25 wherein said latching member is engaged with said release member by manually turning either said first or said second handle.

29. The locking mechanism of claim 25 wherein said latching member is engaged with said release member by turning said second handle in a first direction and said latching member is not engaged with said release member by turning said second handle in a second direction opposite of said second direction.

30. The locking mechanism of claim 25 wherein said locking mechanism is mounted within a door and wherein said latching member and said release member are located so that warpage of said door or misalignment of said door with a door frame does not restrict movement of said latching member and said release member.

31. The locking mechanism of claim 25, wherein said locking mechanism is mounted in a door and rotation of said first handle will allow said door to be opened when said locking mechanism is in a locked position or said locking mechanism is in an unlocked position.
